(19) United States
(12) Patent Application Publication
(10) Pub. No.: US 2026/0133377 A1
(43) Pub. Date: May 14, 2026

(54) ACTIVE OPTICAL CABLE

(71) Applicant: InnoLight Technology (Suzhou) Ltd., Suzhou , Jiangsu (CN)

(72) Inventors: Jingqi Ji, Suzhou , Jiangsu (CN); XIAN ZHOU, Suzhou , Jiangsu (CN); PENG CHEN, Suzhou , Jiangsu (CN); Changwu Lu, Suzhou , Jiangsu (CN); Chao Wang, Suzhou , Jiangsu (CN)

(21) Appl. No.: 19/118,779

(22) PCT Filed: Aug. 24, 2023
(86) PCT No.: PCT/CN2023/114562

§ 371 Date: Apr. 6, 2025

(30) Foreign Application Priority Data
Oct. 17, 2022 (CN) 202222731568.3

(51) Int. Cl. G02B 6/38

(52) U.S. Cl. CPC G02B 6/38875; G02B 6/3869; G02B 6/3893; G02B 6/3897

(57) ABSTRACT

An active optical cable, comprising an optical cable assembly (10) and an optical module (20). The optical cable assembly (10) comprises a first insertion core (11), the optical module (20) comprises a second insertion core (221), and the first insertion core (11) and the second insertion core (221) are joined in an insertion cavity (31) of an adapter (30), so as to achieve optical signal interaction between the optical cable assembly (10) and the optical module (20). The adapter (30) further has a first adjustment structure (32), a housing further has a second adjustment structure (212), and the first adjustment structure (32) and the second adjustment structure (212) are used for acting in concert to adjust the position of the adapter (30) in a mounting cavity (211), so as to adjust the bending of a connecting optical fiber (222). Adjusting the position of the adapter (30) so as to adjust the connecting optical fiber (222) to be in a relatively relaxed state avoids too small of a bending radius of the connecting optical fiber (222) due to excessive bending of the connecting optical fiber (222), and ensures an optical signal transmission effect.

### CROSS-REFERENCE TO RELATED PATENT APPLICATION

The present disclosure claims priority to the Chinese patent application filed with the China Patent Office on Oct. 17, 2022, with the application number 202222731568.3, and the invention name “ACTIVE OPTICAL CABLE,” the entire content of which is incorporated into the present disclosure by reference.

### FIELD OF THE DISCLOSURE

The present disclosure relates to the technical field of optical communication devices, and more particularly to an active optical cable.

### BACKGROUND OF THE DISCLOSURE

Active optical cables (AOC) include optical cables and optical modules at both ends of the optical cables. The optical module can provide photoelectric conversion function and realize optical signal transmission function through the optical cables. It is mainly used for high-speed interconnection between data centers, and devices such as storage devices.

In an AOC product, an insertion core of an optical cable needs to be joined, in an optical module, with an insertion core of the optical module, so as to achieve optical signal interaction between the optical cable and the optical module. In the optical module, the insertion core is optically connected to a circuit board through an optical fiber. Currently, due to unreasonable design of commercially available AOC products, the optical fiber connecting the insertion core and the circuit board is prone to excessive bending, and affects the transmission of an optical signal.

### SUMMARY OF THE DISCLOSURE

The present application provides an active optical cable that can ensure an optical signal transmission effect.

The present application provides an active optical cable. The active optical cable includes: an optical cable assembly, including an optical cable and a first insertion core optically connected to the optical cable; an optical module, including a housing, a circuit board, and an optical assembly, the housing internally has an mounting cavity, the optical assembly is disposed in the mounting cavity, and the optical assembly includes a second insertion core, a connecting optical fiber, and an optoelectronic module; the optoelectronic module is electrically connected to the circuit board, and the second insertion core is optically connected to the optoelectronic module through the connecting optical fiber; and an adapter disposed in the mounting cavity. The adapter internally has an insertion cavity, and the first insertion core and the second insertion core are joined in the insertion cavity; at least a part of the optical cable extends out of the housing, the adapter further has a first adjustment structure, the housing further has a second adjustment structure, and the first adjustment structure and the second adjustment structure are used for acting in concert to adjust the position of the adapter in the mounting cavity, so as to adjust the bending of the connecting optical fiber.

In one embodiment of the present application, the optical module has a first direction, and the first insertion core and the second insertion core are oppositely disposed along the first direction; one of the first adjustment structure and the second adjustment structure is a protrusion, and the other is a slide groove, the slide groove extends along the first direction, and the protrusion is embedded in the slide groove; and the protrusion is configured to be able to move along the slide groove to adjust the position of the adapter in the mounting cavity and be fixed in the slide groove after the position of the adapter is adjusted.

In one embodiment of the present application, the housing includes a first housing and a second housing, the first housing and the second housing are joined to form the mounting cavity, and after adjusting the position of the adapter, the first housing and the second housing act in concert to respectively clamp the adapter from opposite sides of the adapter.

In one embodiment of the present application, the optical module has a first direction, a second direction and a third direction that are perpendicular to each other, the first insertion core and the second insertion core are oppositely disposed along the first direction, and the adapter is embedded in the mounting cavity along the second direction; one end of the adapter adjacent to the first insertion core has: a first claw assembly that includes a first claw and a second claw spaced from each other along the third direction, the first insertion core is inserted into the insertion cavity from a gap between the first claw and the second claw, and the first claw and the second claw are used for acting in concert so that the first insertion core has a tendency to move toward the second insertion core.

In one embodiment of the present application, the adapter further includes an adapter body; each of the first claw and the second claw includes a connecting portion, a bent connecting portion, and an abutting portion. The connecting portion is connected to the adapter body and is further connected to the abutting portion through the bent connecting portion; the bent connecting portion is bent and extends from the connecting portion to the abutting portion, so that the bent connecting portion of the first claw and the bent connecting portion of the second claw are able to be elastically deformed and move away from each other to allow the first insertion core to pass through the gap between the first claw and the second claw, and the abutting portion is used to abut a surface of the first insertion core facing away from the second insertion core after the first insertion core is inserted into the insertion cavity, so that the first insertion core has a tendency to move toward the second insertion core.

In one embodiment of the present application, surfaces of the abutting portion of the first claw and the abutting portion of the second claw that are adjacent to each other are both guide planes extending along the first direction.

In one embodiment of the present application, the bent connecting portion is bent and extends outward relative to the connecting portion.

In one embodiment of the present application, the adapter further includes a first limiting portion and a second limiting portion spaced apart from each other along the second direction. The first limiting portion and the second limiting portion both extend from the adapter body toward the abutting portion and are used for acting in concert to limit the position of the first insertion core in the second direction; and the first claw and the second claw both further include a third limiting portion, the third limiting portion protrudes from a surface of the connecting portion facing the insertion cavity, and the third limiting portion is used to limit the position of the first insertion core in the third direction.

In one embodiment of the present application, the optical module has a second direction, and the adapter is embedded in the mounting cavity along the second direction; one end of the adapter adjacent to the second insertion core has: a second claw assembly that includes a third claw and a fourth claw spaced apart from each other along the second direction, the second insertion core is inserted into the insertion cavity from a gap between the third claw and the fourth claw, and the third claw and the fourth claw are used for acting in concert so that the second insertion core has a tendency to move toward the first insertion core.

In one embodiment of the present application, the optical module further has a first direction and a third direction, the first insertion core and the second insertion core are oppositely disposed along the first direction, and the first direction, the second direction, and the third direction are perpendicular to each other; the adapter further includes an adapter body, and a side wall of the adapter body in the third direction has a first groove body and a second groove body. The first groove body and the second groove body are spaced apart from each other along the second direction, the first groove body and the second groove body both extend along the first direction, and end portions of both the first groove body and the second groove body facing the third claw and the fourth claw are openings.

In one embodiment of the present application, the optical module has a first direction, and the first insertion core and the second insertion core are oppositely disposed along the first direction; the adapter further has: a first claw assembly, disposed at one end of the adapter adjacent to the first insertion core, and the first claw assembly has a first abutting surface for abutting the first insertion core; and a second claw assembly, disposed at one end of the adapter adjacent to the second insertion core, and the second claw assembly has a second abutting surface for abutting the second insertion core; when the first insertion core and the second insertion core are not inserted into the insertion cavity, an initial distance is present between the first abutting surface and the second abutting surface in the first direction, and the initial distance is less than a sum of lengths of the first insertion core and the second insertion core in the first direction.

In one embodiment of the present application, each of the first claw assembly and/or the second claw assembly has an observation hole to measure the initial distance through the observation hole.

The beneficial effect of the present application is that, different from the existing technologies, the present application provides an active optical cable. The active optical cable includes an optical cable assembly and an optical module. The optical cable assembly includes a first insertion core, and the optical module includes a second insertion core. The first insertion core and the second insertion core are joined in an insertion cavity of an adapter to achieve optical signal interaction between the optical cable assembly and the optical module.

In addition, the adapter further has a first adjustment structure, and the housing further has a second adjustment structure, and the first adjustment structure and the second adjustment structure are used to act in concert to adjust the position of the adapter in the mounting cavity, so as to adjust the bending of a connecting optical fiber. In other words, the present application allows the connecting optical fiber to be adjusted to a relatively relaxed state by adjusting the position of the adapter, thereby avoiding too small of a bending radius of the connecting optical fiber due to excessive bending of the connecting optical fiber, and ensures an optical signal transmission effect.

### BRIEF DESCRIPTION OF THE DRAWINGS

In order to more clearly illustrate the technical solutions in the embodiments of the present application, the drawings required for use in the description of the embodiments will be briefly introduced below. Apparently, the drawings described below are only certain embodiments of the present application. For those skilled in the art, other drawings can be obtained based on these drawings with no need of any creative work.

FIG. 1 is a schematic structural diagram of an active optical cable according to one embodiment of the present application;

FIG. 2 is a schematic partial structural diagram of the active optical cable as shown in FIG. 1;

FIG. 3 is a schematic structural diagram of an adapter applied in the active optical cable according to one embodiment of the present application;

FIG. 4 is a schematic structural diagram of one implementation of a housing of the present application;

FIG. 5 is a schematic top view diagram of the structure of the adapter as shown in FIG. 3.

### DESCRIPTION OF REFERENCE NUMERALS

10 optical cable assembly; 11 first insertion core; 12 optical cable; 20 optical module; 21 housing; 211 mounting cavity; 212 second adjustment structure; 213 first housing; 214 second housing; 22 optical assembly; 221 second insertion core; 222 connecting optical fiber; 223 circuit board; 30 adapter; 31 insertion cavity; 32 first adjustment structure; 33 first claw assembly; 331 first claw; 332 second claw; 333a, 333b connecting portion: 334a, 334b bent connecting portion; 335a, 335b abutting portion; 336a, 336b guide plane; 337a, 337b third limiting portion; 338 first abutting surface; 34 adapter body; 341 first groove body; 342 second groove body; 351 first limiting portion; 352 second limiting portion; 36 second claw assembly; 361 third claw; 362 fourth claw; 363a, 363b guide slope; 364 second abutting surface; 371 first elastic portion; 372 second elastic portion; 38 observation hole.

### DETAILED DESCRIPTION OF THE EXEMPLARY EMBODIMENTS

The technical solutions in the embodiments of the present application will be clearly and completely described below in conjunction with the drawings in the embodiments of the present application. Apparently, the described embodiments are only part of the embodiments of the present application, rather than all of the embodiments. Based on the embodiments in the present application, all other embodiments obtained by those skilled in the art with no need for creative work are within the scope of protection of the present application. In addition, it should be understood that, the specific implementation methods described herein are only used to illustrate and explain the present application and are not used to limit the present application. In the present application, unless otherwise stated, the directional words used, such as “up,” “down,” “left,” and “right,” generally refer to the up, down, left, and right of the device in actual use or working state, specifically the direction of figures in the accompanying figures.

The present application provides an active optical cable and an adapter and an optical module used therein, which are described in detail below. It should be noted that, the description order of the following embodiments is not intended to limit the preferred order of the embodiments of the present application. In the following embodiments, the description of each embodiment has its own emphasis. For parts that are not described in detail in a particular embodiment, reference can be made to the relevant description of other embodiments.

In order to address the technical problems in the existing technology that the connection insertion core in an AOC optical module is fixed and the connecting optical fiber is prone to excessive bending, which affects the transmission of optical signals, one embodiment of the present application provides an active optical cable. The active optical cable includes an optical cable assembly, and the optical cable assembly includes a first insertion core. The active optical cable further includes an optical module, the optical module includes a housing and an optical assembly, the housing internally has a mounting cavity, the optical assembly is disposed in the mounting cavity, the optical assembly includes a second insertion core, a connecting optical fiber, and a circuit board, and the second insertion core is optically connected to the circuit board through the connecting optical fiber. The active optical cable further includes an adapter, the adapter is disposed in the mounting cavity, the adapter internally has an insertion cavity, and the first insertion core and the second insertion core are joined in the insertion cavity. Here, the adapter further has a first adjustment structure, the housing further has a second adjustment structure, and the first adjustment structure and the second adjustment structure are used for acting in concert to adjust a position of the adapter in the mounting cavity to adjust the bending of the connecting optical fiber. Details of the above are explained as follows.

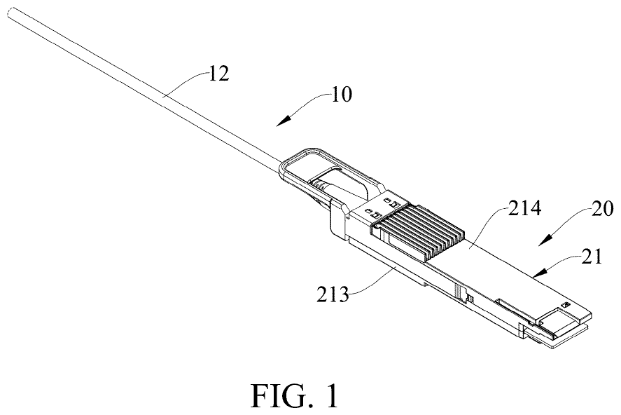

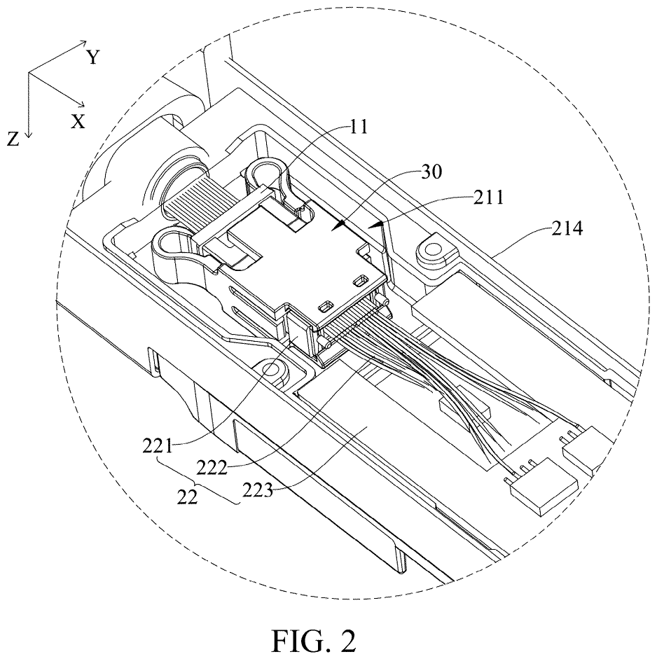

Reference can be made to FIG. 1 and FIG. 2, FIG. 1 is a schematic structural diagram of an active optical cable according to one embodiment of the present application, and FIG. 2 is a schematic partially structural diagram of the active optical cable as shown in FIG. 1. In FIG. 2, a housing 21 of an optical module 20 is omitted.

In one embodiment, the active optical cable can be an optical communication device such as an AOC. The active optical cable includes an optical cable assembly 10 and the optical module 20. The optical module 20 is located at one end of the optical cable assembly 10. The optical module 20 provides an optoelectronic conversion function capable of converting an optical signal transmitted by the optical cable assembly 10 into an electrical signal, or converting an electrical signal into an optical signal and transmitting it by using the optical cable assembly 10.

The optical cable assembly 10 includes an optical cable 12 and a first insertion core 11 optically connected to the optical cable 12, and the optical module 20 includes a second insertion core 221. The first insertion core 11 and the second insertion core 221 are joined in the optical module 20, so that the optical cable assembly 10 is optically connected to the optical module 20, thereby achieving optical signal interaction between the optical cable assembly 10 and the optical module 20. Here, the optical connection between the two components should be understood as the ability to establish a transmission path for optical signals between the two components. It should be noted that, for the example in which the active optical cable is an AOC, the first insertion core 11 and the second insertion core 221 are corresponding MT insertion cores.

Specifically, the optical module 20 includes a housing 21, a circuit board 223, and an optical assembly 22. The housing 21 is the basic carrier of the optical module 20, and provides the functions of bearing and protecting for other components of the optical module 20; here, the housing 21 internally has a mounting cavity 211, and at least part of the optical cable 12 extends out of the housing 21. The optical assembly 22 is disposed in the mounting cavity 211, and the optical assembly 22 is used to convert the optical signal transmitted by the optical cable assembly 10 into an electrical signal, or convert the electrical signal into an optical signal and transmit it to the optical cable assembly 10. The optical assembly 22 includes the second insertion core 221, a connecting optical fiber 222, and an optoelectronic module, the optoelectronic module is electrically connected to the circuit board 223, and the second insertion core 221 is optically connected to the optoelectronic module through the connecting optical fiber 222. After the first insertion core 11 and the second insertion core 221 are joined, they are optically connected with each other. The optical signal transmitted by the optical cable assembly 10 is transmitted to the circuit board 223 through the first insertion core 11 and the second insertion core 221 to be converted into an electrical signal, or the electrical signal of the circuit board 223 is converted into an optical signal and then transmitted to the optical cable assembly 10 through the first insertion core 11 and the second insertion core 221. Here, the optoelectronic module may include such as an optical transceiver element.

The active optical cable further includes an adapter 30. The adapter 30 is disposed in the mounting cavity 211, the adapter 30 internally has an insertion cavity 31, and the first insertion core 11 and the second insertion core 221 are joined in the insertion cavity 31. The adapter 30 is used to enable the first insertion core 11 and the second insertion core 221 to be reliably joined to ensure the stability of the optical path between the first insertion core 11 and the second insertion core 221.

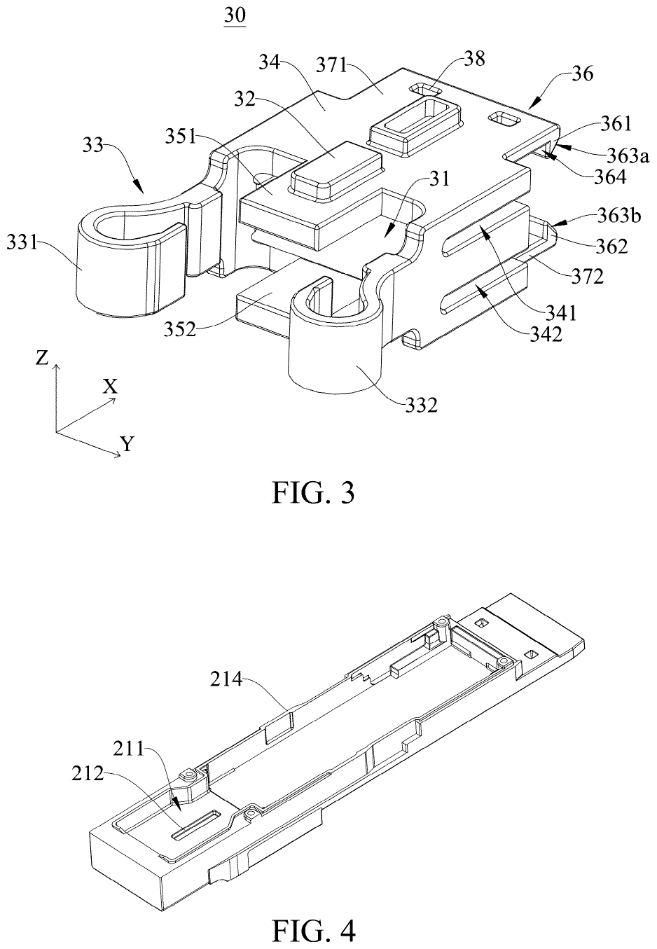

It should be noted that, referring to FIG. 3 and FIG. 4, the adapter 30 of this embodiment further has a first adjustment structure 32, and the housing 21 further has a second adjustment structure 212. The first adjustment structure 32 and the second adjustment structure 212 are used for acting in concert to adjust the position of the adapter 30 in the mounting cavity 211, so as to adjust the bending of the connecting optical fiber 222. In other words, this embodiment allows the connecting optical fiber 222 to be adjusted to a relatively relaxed state by adjusting the position of the adapter 30, so as to avoid excessive bending of the connecting optical fiber 222 and causing the bending radius of the connecting optical fiber 222 to be too small, thereby ensuring the optical signal transmission effect. If the bending radius of the connecting optical fiber 222 is too small, it will have an adverse effect on the optical signal transmission effect of the connecting optical fiber 222.

Further, the optical module 20 has a first direction (as shown by arrow X in FIG. 2 and FIG. 3, similarly hereinafter), the first insertion core 11 and the second insertion core 221 are oppositely disposed along the first direction, and the first direction is also the direction in which the first insertion core 11 and the second insertion core 221 are inserted into the insertion cavity 31. One of the first adjustment structure 32 and the second adjustment structure 212 is a protrusion, and the other is a slide groove. The slide groove extends along the first direction, and the protrusion is embedded in the slide groove. The protrusion is configured to be able to move along the slide groove to adjust the position of the adapter 30 in the mounting cavity 211 and can be fixed in the slide groove after the position of the adapter 30 is adjusted.

For example, the first adjustment structure 32 of the adapter 30 is specifically a protrusion protruding from an outer wall of the adapter 30. Here, the number of protrusions may be one or two or more, FIG. 3 shows a case where there are two protrusions, and the two protrusions are spaced apart from each other along the first direction. The protrusions are located at a bottom of the adapter 30. As shown in FIG. 4, the second adjustment structure 212 of the housing 21 is specifically a slide groove. The inner wall of the housing 21 of the optical module 20 is recessed to form a slide groove, and the slide groove is located at a bottom of the housing 21. The protrusion on the adapter 30 is embedded in the slide groove and can move along the slide groove, that is, the adapter 30 can move along the first direction so as to adjust the position of the adapter 30 in the first direction, thereby adjusting the bending of the connecting optical fiber 222.

Furthermore, the housing 21 includes a first housing 213 and a second housing 214, which are joined to form the mounting cavity 211, and after adjusting the position of the adapter 30, the first housing 213 and the second housing 214 act in concert to respectively clamp the adapter 30 from opposite sides of the adapter 30, that is, fix the adjusted position of the adapter 30.

Naturally, in other embodiments of the present application, the first adjustment structure 32 may be the slide groove, and the second adjustment structure 212 may be the protrusion, but are not limited thereto.

The adapter 30 according to one embodiment of the present application is described as follows.

In one embodiment, the optical module 20 has a first direction, a second direction (as shown by arrows Z in FIG. 2 and FIG. 3, similarly hereinafter), and a third direction (as shown by arrows Y in FIG. 3, similarly hereinafter) which are perpendicular to each other. The adapter 30 is embedded in the mounting cavity 211 along the second direction. Specifically, in the case where the first adjustment structure 32 is located at the bottom of the adapter 30 and the second adjustment structure 212 is located at the bottom of the housing 21, the second direction is a height direction of the optical module 20. After the first insertion core 11 and the second insertion core 221 are both inserted into the insertion cavity 31, the adapter 30 is embedded in the mounting cavity 211 along the second direction such that the first adjustment structure 32 and the second adjustment structure 212 are matched and connected. Correspondingly, the first direction is a length direction of the optical module 20, and the third direction is a width direction of the optical module 20.

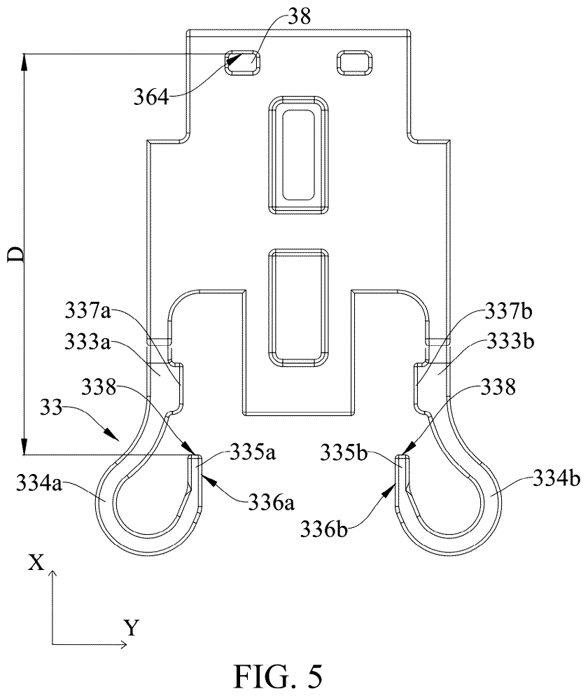

Reference can be made to FIG. 5, which is a schematic top view diagram of the structure of the adapter as shown in FIG. 3.

In one embodiment, the adapter 30 has a first claw assembly 33, and the first claw assembly 33 is located at one end of the adapter 30 adjacent to the first insertion core 11. The first claw assembly 33 has a first abutting surface 338 for abutting the first insertion core 11. The first claw assembly 33 abuts the first insertion core 11 through the first abutting surface 338, so that the first insertion core 11 has a tendency to move toward the second insertion core 221, thereby enabling the first insertion core 11 and the second insertion core 221 to be tightly joined.

Specifically, the first claw assembly 33 includes a first claw 331 and a second claw 332 spaced apart from each other along the third direction. The first insertion core 11 is inserted into the insertion cavity 31 from a gap between the first claw 331 and the second claw 332. The first claw 331 and the second claw 332 are used for acting in concert so that the first insertion core 11 has a tendency to move toward the second insertion core 221.

Furthermore, the adapter 30 further includes an adapter body 34, and the adapter body 34 surrounds to form the insertion cavity 31. The first claw 331 includes a connecting portion 333a, a bent connecting portion 334a, and an abutting portion 335a. The connecting portion 333a is connected to the adapter body 34 and is further connected to the abutting portion 335a through the bent connecting portion 334a, the bent connecting portion 334a is bent and extends from the connecting portion 333a to the abutting portion 335a, and the bent connecting portion 334a is able to be elastically deformed. The second claw 332 includes a connecting portion 333b, a bent connecting portion 334b, and an abutting portion 335b. The connecting portion 333b is connected to the adapter body 34 and is further connected to the abutting portion 335b through the bent connecting portion 334b, the bent connecting portion 334b is bent and extends from the connecting portion 333b to the abutting portion 335b, and the bent connecting portion 334b is able to be elastically deformed. An end surface of the abutting portion 335a of the first claw 331 facing the second insertion core 221 and an end surface of the abutting portion 335b of the second claw 332 facing the second insertion core 221 are the first abutting surfaces 338.

The bent connecting portion 334a of the first claw 331 and the bent connecting portion 334b of the second claw 332 can undergo elastic deformation and move away from each other to allow the first insertion core 11 to pass through the gap between the first claw 331 and the second claw 332, and the abutting portion 335a of the first claw 331 and the abutting portion 335b of the second claw 332 are both used to abut a surface of the first insertion core 11 away from the second insertion core 221 after the first insertion core 11 is inserted into the insertion cavity 31, such that the first insertion core 11 has a tendency to move toward the second insertion core 221.

Optionally, the bent connecting portion 334a of the first claw 331 is bent and extends outward relative to the connecting portion 333a. Specifically, the bent connecting portion 334a of the first claw 331 is bent and extends outward toward the outside of the adapter 30 along the third direction, such that the first claw 331 is hook-shaped as a whole, thereby enabling the first claw 331 to have good elastic deformation capability. The first claw 331 is easily deformed in response to the action of the first insertion core 11 being inserted into the insertion cavity 31, so as to absorb an interference fit amount between the first claw 331 and the first insertion core 11, thereby facilitating the smooth insertion of the first insertion core 11 into the insertion cavity 31. Similarly, the bent connecting portion 334b of the second claw 332 is bent and extends outward relative to the connecting portion 333b. Specifically, the bent connecting portion 334b of the second claw 332 is bent and extends outward toward the outside of the adapter 30 along the third direction, such that the second claw 332 is hook-shaped as a whole, thereby enabling the second claw 332 to have good elastic deformation capability. The second claw 332 is easily deformed in response to the first insertion core 11 being inserted into the insertion cavity 31, so as to absorb an interference fit amount between the second claw 332 and the first insertion core 11, thereby facilitating the smooth insertion of the first insertion core 11 into the insertion cavity 31.

In one embodiment, the surfaces of the abutting portion 335a of the first claw 331 and the abutting portion 335b of the second claw 332 that are adjacent to each other are both guide planes that extend along the first direction. Specifically, the surface of the abutting portion 335a of the first claw 331 facing the abutting portion 335b of the second claw 332 is a guide plane 336a, and the surface of the abutting portion 335b of the second claw 332 facing the abutting portion 335a of the first claw 331 is a guide plane 336b.

The first insertion core 11 is inserted into the insertion cavity 31 from the gap between the first claw 331 and the second claw 332; specifically, the first insertion core 11 is inserted into the insertion cavity 31 from the gap between the abutting portion 335a of the first claw 331 and the abutting portion 335b of the second claw 332. When the first insertion core 11 passes through the gap, two sides of the first insertion core 11 in the third direction will contact the guide plane 336a and the guide plane 336b, respectively. Since the guide plane 336a and the guide plane 336b both extend along the first direction, that is, an extension direction of the guide plane 336a and the guide plane 336b is parallel to the direction in which the first insertion core 11 is inserted into the insertion cavity 31, the guide plane 336a and the guide plane 336b can guide the first insertion core 11 to pass through the gap between the first claw 331 and the second claw 332, such that the first insertion core 11 can be smoothly inserted into the insertion cavity 31.

It should be noted that, the guide plane 336a and the guide plane 336b both extend in the first direction, indicating that the guide plane 336a and the guide plane 336b both have sufficient length in the first direction to ensure that the guide plane 336a and the guide plane 336b have a good guiding effect. In addition, the guide plane 336a and the guide plane 336b have a large contact area with the first insertion core 11, which can prevent the first claw 331 and the second claw 332 from pinching and damaging the first insertion core 11.

In one embodiment, the abutting portion 335a of the first claw 331 and the abutting portion 335b of the second claw 332 are used for acting in concert such that the first insertion core 11 has a tendency to move toward the second insertion core 221, so as to cooperate with the second insertion core 221 to limit the position of the first insertion core 11 in the first direction, thereby facilitating the stabilization of the position of the first insertion core 11 in the insertion cavity 31.

The adapter 30 further includes a first limiting portion 351 and a second limiting portion 352 spaced apart from each other along the second direction. The first limiting portion 351 and the second limiting portion 352 both extend from the adapter body 34 toward the abutting portion 335 of the first claw 331 and the second claw 332, and are used for acting in concert to limit the position of the first insertion core 11 in the second direction. After the first insertion core 11 is inserted into the insertion cavity 31, the first limiting portion 351 and the second limiting portion 352 can respectively abut against the two side surfaces of the first insertion core 11 in the second direction, so as to act in concert to limit the position of the first insertion core 11 in the second direction, thereby facilitating the stabilization of the position of the first insertion core 11 in the insertion cavity 31.

The first claw 331 further includes a third limiting portion 337a, which protrudes from a surface of the connecting portion 333a facing the insertion cavity 31, and the third limiting portion 337a is used to limit the position of the first insertion core 11 in the third direction. Similarly, the second claw 332 further includes a third limiting portion 337b, which protrudes from a surface of the connecting portion 333b facing the insertion cavity 31, and the third limiting portion 337a is used to limit the position of the first insertion core 11 in the third direction. In other words, after the first insertion core 11 is inserted into the insertion cavity 31, the third limiting portion 337a and the third limiting portion 337b can respectively abut against the two side surfaces of the first insertion core 11 in the third direction, so as to act in concert to limit the position of the first insertion core 11 in the third direction, thereby facilitating the stabilization of the position of the first insertion core 11 in the insertion cavity 31.

In one embodiment, the adapter 30 further includes a second claw assembly 36, and the second claw assembly 36 is located at one end of the adapter 30 adjacent to the second insertion core 221. The second claw assembly 36 includes a second abutting surface 364 for abutting the second insertion core 221, and the second claw assembly 36 abuts the second insertion core 221 through the second abutting surface 364, such that the second insertion core 221 has a tendency to move toward the first insertion core 11, thereby enabling the first insertion core 11 and the second insertion core 221 to be tightly joined.

Specifically, the second claw assembly 36 includes a third claw 361 and a fourth claw 362 spaced apart from each other along the second direction. The second insertion core 221 is inserted into the insertion cavity 31 from a gap between the third claw 361 and the fourth claw 362. The third claw 361 and the fourth claw 362 are used to act in concert such that the second insertion core 221 has a tendency to move toward the first insertion core 11.

Further, the second claw assembly 36 further includes a first elastic portion 371 and a second elastic portion 372. The first elastic portion 371 extends in a direction away from the adapter body 34 to connect with the third claw 361. The second elastic portion 372 extends in a direction away from the adapter body 34 to connect with the fourth claw 362.

The first elastic portion 371 and the second elastic portion 372 can both be elastically deformed such that end portions of the two away from the adapter body 34 are away from each other, that is, the gap between the third claw 361 and the fourth claw 362 is increased to allow the second insertion core 221 to pass through the gap between the third claw 361 and the fourth claw 362. After the second insertion core 221 is inserted into the insertion cavity 31, the first elastic portion 371 and the second elastic portion 372 can also respond to their respective elastic restoration forces, such that the end portions of the first elastic portion 371 and the second elastic portion 372 away from the adapter body 34 have a tendency to approach each other, and the third claw 361 and the fourth claw 362 act in concert to enable the second insertion core 221 to have a tendency to move toward the first insertion core 11.

It should be noted that, in the embodiment of the present application, by reasonably selecting the material of the adapter 30, the first claw 331 and the second claw 332 of the adapter 30 have good elastic deformation capability, and the first elastic portion 371 and the second elastic portion 372 have good elastic deformation capability. In addition, the strength and fatigue resistance of the adapter 30 can meet the product requirements.

Furthermore, the third claw 361 and the fourth claw 362 are both protruded from an inner wall of the adapter 30. The third claw 361 is located at the end of the first elastic portion 371 away from the adapter body 34, the third claw 361 protrudes toward the second elastic portion 372 relative to the first elastic portion 371, and the third claw 361 is barb-shaped as a whole. Similarly, the fourth claw 362 is located at the end of the second elastic portion 372 away from the adapter body 34, the fourth claw 362 protrudes toward the first elastic portion 371 relative to the second elastic portion 372, and the fourth claw 362 is barb-shaped as a whole.

One side of the third claw 361 facing the circuit board 223 has a guiding slope 363a, which is used to guide the second insertion core 221 through the gap between the third claw 361 and the fourth claw 362. The guiding slope 363a extends toward the first claw assembly 33 and the second elastic portion 372. Similarly, one side of the fourth claw 362 facing the circuit board 223 has a guiding slope 363b, which is used to guide the second insertion core 221 through the gap between the third claw 361 and the fourth claw 362. The guiding slope 363b extends toward the first claw assembly 33 and the first elastic portion 371. In other words, in the process of inserting the second insertion core 221 into the insertion cavity 31, the second insertion core 221 is guided through the gap between the third claw 361 and the fourth claw 362 by the guiding slope 363a on the third claw 361 and the guiding slope 363b on the fourth claw 362, such that the second insertion core 221 can be smoothly inserted into the insertion cavity 31.

It should be noted that, since a rear end of the second insertion core 221 is connected to the connecting optical fiber 222, the first insertion core 11 and the second insertion core 221 are often joined with the aid of a pin needle to ensure the joining accuracy. In this embodiment, the second insertion core 221 is inserted into the insertion cavity 31 from the gap between the third claw 361 and the fourth claw 362, such that the third claw 361 and the fourth claw 362 can avoid the connecting optical fiber 222, the pin needle, or the supporting structure of the pin needle, and at the same time allow an end portion of the adapter 30 adjacent to the second insertion core 221 to have the third claw 361 and the fourth claw 362. The third claw 361 and the fourth claw 362 can reliably keep the first insertion core 11 and the second insertion core 221 to be tightly joined. In this embodiment, the adapter 30 can individually achieve the tight joining of the first insertion core 11 and the second insertion core 221 without the aid of other structures.

In one embodiment, the adapter 30 enables, through the first claw assembly 33 and the second claw assembly 36 thereon, the first insertion core 11 and the second insertion core 221 to be tightly joined. Since the position of the adapter 30 in the optical module 20 is fixed after adjusting the bending condition of the connecting optical fiber 222, it indicates that the first claw assembly 33 and the second claw assembly 36 can act in concert to limit the position of the first insertion core 11 and the second insertion core 221 in the first direction. In addition, the first elastic portion 371 and the second elastic portion 372 of the adapter 30 both abut against the second insertion core 221, so as to limit the position of the second insertion core 221 in the second direction. In addition, inner walls on both sides of the adapter body 34 in the third direction also abut against the second insertion core 221, so as to limit the position of the second insertion core 221 in the third direction.

In one embodiment, the side walls of the adapter body 34 in the third direction has a first groove body 341 and a second groove body 342, the first groove body 341 and the second groove body 342 are spaced apart from each other along the second direction, and the first groove body 341 and the second groove body 342 both extend along the first direction and both have openings at their end portions facing the third claw 361 and the fourth claw 362.

The first groove body 341 extends toward the third claw 361 along the first direction, an end portion of the first groove body 341 facing the third claw 361 penetrates the adapter body 34 to form an opening, and an end portion of the first groove body 341 away from the third claw 361 is closed. Similarly, the second groove body 342 extends toward the fourth claw 362 along the first direction, an end portion of the second groove body 342 facing the fourth claw 362 penetrates the adapter body 34 to form an opening, and an end portion of the second groove body 342 away from the fourth claw 362 is closed. Further, the first groove body 341 and the second groove body 342 are formed on both side walls of the adapter body 34 in the third direction.

In one aspect, in the manufacturing processes for the adapter 30 of this embodiment, the structure of the internal cavity of the adapter 30 needs to be formed by means of a mold. In this embodiment, by forming the first groove body 341 and the second groove body 342 in the second direction, the mold can be designed as three pieces stacked in the second direction, upper and lower molds are respectively released along the third direction through the first groove body 341 and the second groove body 342, and a middle mold is released along the first direction through the gap between the third claw 361 and the fourth claw 362; that is, this embodiment can facilitate the mold release after the adapter 30 is formed.

On the other hand, through the first groove bodies 341 on both sides of the adapter body 34, a portion of the adapter body 34 connected to the first elastic portion 371 and the first elastic portion 371 together form a cantilever connected to the third claw 361, and the cantilever has a large arm length, such that the third claw 361 is easy to open for the second insertion core 221 to be inserted into the insertion cavity 31. Similarly, through the second groove bodies 342 on both sides of the adapter body 34, a portion of the adapter body 34 connected to the second elastic portion 372 and the second elastic portion 372 together form a cantilever connected to the fourth claw 362, and the cantilever has a large arm length, such that the fourth claw 362 is easy to open for the second insertion core 221 to be inserted into the insertion cavity 31.

In one embodiment, when the first insertion core 11 and the second insertion core 221 are not inserted into the insertion cavity 31, an initial distance is present between the first abutting surface 338 of the first claw assembly 33 and the second abutting surface 364 of the second claw assembly 36 in the first direction (as shown in D in FIG. 5, similarly hereinafter), and the initial distance is smaller than a sum of the lengths of the first insertion core 11 and the second insertion core 221 in the first direction.

In other words, after the first insertion core 11 and the second insertion core 221 are joined, the initial distance is less than the sum of the lengths of the first insertion core 11 and the second insertion core 221 in the first direction. In this embodiment, the first claw assembly 33 and the second claw assembly 36 have interference fit with the first insertion core 11 and the second insertion core 221, such that the first insertion core 11 and the second insertion core 221 are reliably and tightly fitted in the adapter 30.

Furthermore, since the sum of the lengths of the first insertion core 11 and the second insertion core 221 in the first direction is determined, an interference fit amount can be reasonably set by reasonably setting the initial distance between the first abutting surface 338 and the second abutting surface 364 in the first direction, such that the clamping force of the first claw assembly 33 and the second claw assembly 36 clamping the first insertion core 11 and the second insertion core 221 meets the requirements.

Accordingly, in this embodiment, the first claw assembly 33 and/or the second claw assembly 36 has an observation hole 38 for measuring the above-mentioned initial distance through the observation hole 38.

For example, the first elastic portion 371 and/or the second elastic portion 372 of the second claw assembly 36 has an observation hole 38, and the observation hole 38 is adjacent to and exposes the second abutting surface 364 of the second claw assembly 36, such that the second abutting surface 364 can be observed through the observation hole 38. The initial distance between the first abutting surface 338 and the second abutting surface 364 in the first direction can be measured. Based on the measurement result, it is determined whether or not the interference fit amount meets the requirement, which is conducive to ensure that the clamping force of the first claw assembly 33 and the second claw assembly 36 clamping the first insertion core 11 and the second insertion core 221 meets the requirement. In this embodiment, it is preferred that the first elastic portion 371 and the second elastic portion 372 both have the observation hole 38, and each of the first elastic portion 371 and the second elastic portion 372 has two observation holes 38 spaced from each other along the third direction. Furthermore, in other embodiments of the present application, the first claw assembly 33 can adopt the same structure as the second claw assembly 36. In this case, the first claw assembly 33 can also have observation holes 38 to facilitate measuring the initial distance between the first abutting surface 338 and the second abutting surface 364 in the first direction.

In one embodiment, an active optical cable includes a first insertion core 11 and an optical module 20. The optical module 20 includes a second insertion core 221. An adapter 30 applied to the active optical cable internally has an insertion cavity 31, and the first insertion core 11 and the second insertion core 221 are joined in the insertion cavity 31. The adapter 30 further has a first adjustment structure 32, and the first adjustment structure 32 is used for acting in concert with a corresponding adjustment structure in the optical module 20 to adjust the position of the adapter 30 in the optical module 20. Here, the first insertion core 11, the second insertion core 221, the optical module 20, and the adapter 30 have been described in detail in the above embodiments, and will not be reiterated herein.

In one embodiment, an active optical cable includes a first insertion core 11 and an adapter 30. An optical module 20 applied to the active optical cable includes a housing 21, and the housing 21 internally has a mounting cavity 211. The optical module 20 further includes a second insertion core 221 disposed in the mounting cavity 211, and the first insertion core 11 and the second insertion core 221 are joined in the adapter 30. The housing 21 further has a second adjustment structure 212, and the second adjustment structure 212 is used for acting in concert with the corresponding adjustment structure on the adapter 30 to adjust the position of the adapter 30 in the mounting cavity 211. Here, the first insertion core 11, the second insertion core 221, the optical module 20, and the adapter 30 have been described in detail in the above embodiments, and will not be reiterated herein.

In summary, in the active optical cable provided by the present application and the adapter and optical module used therein, the active optical cable includes an optical cable assembly and an optical module. The optical cable assembly includes a first insertion core, and the optical module includes a second insertion core. The first insertion core and the second insertion core are joined in the insertion cavity of the adapter to achieve optical signal interaction between the optical cable assembly and the optical module.

In addition, the adapter further has a first adjustment structure, and the housing further has a second adjustment structure, and the first adjustment structure and the second adjustment structure are used to act in concert to adjust the position of the adapter in the mounting cavity, so as to adjust the bending of a connecting optical fiber. In other words, the present application allows the connecting optical fiber to be adjusted to a relatively relaxed state by adjusting the position of the adapter, thereby avoiding too small of a bending radius of the connecting optical fiber due to excessive bending of the connecting optical fiber, and ensures an optical signal transmission effect.

The active optical cable and the adapter and optical module used in the present application are introduced in detail above. The principle and implementation modes of the present application are described in detail using specific examples. The description of the above embodiments is only used to assist in understanding the method and core idea of the present application. At the same time, for those skilled in the art, according to the idea of the present application, changes in the specific implementation mode and application scope can be made. In summary, the content of this specification should not be understood as limiting the present application.

1. An active optical cable, characterized by comprising:
an optical cable assembly including an optical cable and a first insertion core optically connected to the optical cable;
an optical module including a housing, a circuit board, and an optical assembly, wherein the housing internally has a mounting cavity, the optical assembly is disposed in the mounting cavity, and the optical assembly includes a second insertion core, a connecting optical fiber, and an optoelectronic module; the optoelectronic module is electrically connected to the circuit board, and the second insertion core is optically connected to the optoelectronic module through the connecting optical fiber; and
an adapter disposed in the mounting cavity, wherein the adapter internally has an insertion cavity, and the first insertion core and the second insertion core are joined in the insertion cavity;
wherein at least a part of the optical cable extends out of the housing, the adapter further has a first adjustment structure, the housing further has a second adjustment structure, and the first adjustment structure and the second adjustment structure are used for acting in concert to adjust a position of the adapter in the mounting cavity, so as to adjust a bending of the connecting optical fiber.

2. The active optical cable according to claim 1, characterized in that,
the optical module has a first direction, and the first insertion core and the second insertion core are oppositely disposed along the first direction; one of the first adjustment structure and the second adjustment structure is a protrusion, and the other is a slide groove; the slide groove extends along the first direction, and the protrusion is embedded in the slide groove; and the protrusion is configured to be able to move along the slide groove to adjust the position of the adapter in the mounting cavity and be fixed in the slide groove after the position of the adapter is adjusted.

3. The active optical cable according to claim 1, characterized in that,
the housing includes a first housing and a second housing, the first housing and the second housing are joined to form the mounting cavity, and after adjusting the position of the adapter, the first housing and the second housing act in concert to respectively clamp the adapter from opposite sides of the adapter.

4. The active optical cable according to claim 1, characterized in that
the optical module has a first direction, a second direction, and a third direction which are perpendicular to each other, the first insertion core and the second insertion core are oppositely disposed along the first direction, and the adapter is embedded in the mounting cavity along the second direction;
one end of the adapter adjacent to the first insertion core has:
a first claw assembly that includes a first claw and a second claw spaced apart from each other along the third direction, the first insertion core is inserted into the insertion cavity from a gap between the first claw and the second claw, and the first claw and the second claw are used for acting in concert so that the first insertion core has a tendency to move toward the second insertion core.

5. The active optical cable according to claim 4, characterized in that,
the adapter further includes an adapter body;
each of the first claw and the second claw includes a connecting portion, a bent connecting portion, and an abutting portion, wherein the connecting portion is connected to the adapter body and is further connected to the abutting portion through the bent connecting portion;
the bent connecting portion is bent and extends from the connecting portion to the abutting portion, so that the bent connecting portion of the first claw and the bent connecting portion of the second claw are able to be elastically deformed and move away from each other to allow the first insertion core to pass through the gap between the first claw and the second claw, and the abutting portion is used to abut a surface of the first insertion core facing away from the second insertion core after the first insertion core is inserted into the insertion cavity, so that the first insertion core has a tendency to move toward the second insertion core.

6. The active optical cable according to claim 5, characterized in that,
surfaces of the abutting portion of the first claw and the abutting portion of the second claw that are adjacent to each other are both guide planes extending along the first direction.

7. The active optical cable according to claim 5, characterized in that,
the bent connecting portion is bent and extends outward relative to the connecting portion.

8. The active optical cable according to claim 5, characterized in that,
the adapter further includes a first limiting portion and a second limiting portion spaced apart from each other along the second direction, wherein the first limiting portion and the second limiting portion both extend from the adapter body toward the abutting portion and are used for acting in concert to limit a position of the first insertion core in the second direction; and
the first claw and the second claw both further include a third limiting portion, the third limiting portion protrudes from a surface of the connecting portion facing the insertion cavity, and the third limiting portion is used to limit a position of the first insertion core in the third direction.

9. The active optical cable according to claim 1, characterized in that,
the optical module has a second direction, and the adapter is embedded in the mounting cavity along the second direction;
one end of the adapter adjacent to the second insertion core has:
a second claw assembly that includes a third claw and a fourth claw spaced apart from each other along the second direction, the second insertion core is inserted into the insertion cavity from a gap between the third claw and the fourth claw, and the third claw and the fourth claw are used for acting in concert so that the second insertion core has a tendency to move toward the first insertion core.

10. The active optical cable according to claim 9, characterized in that
the optical module further has a first direction and a third direction, the first insertion core and the second insertion core are oppositely disposed along the first direction, and the first direction, the second direction, and the third direction are perpendicular to each other;
the adapter further includes an adapter body, and a side wall of the adapter body in the third direction has a first groove body and a second groove body, wherein the first groove body and the second groove body are spaced apart from each other along the second direction, the first groove body and the second groove body both extend along the first direction, and end portions of both the first groove body and the second groove body facing the third claw and the fourth claw are openings.

11. The active optical cable according to claim 1, characterized in that,
the optical module has a first direction, and the first insertion core and the second insertion core are oppositely disposed along the first direction;
the adapter further has:
a first claw assembly, disposed at one end of the adapter adjacent to the first insertion core, and the first claw assembly has a first abutting surface for abutting the first insertion core; and
a second claw assembly disposed at one end of the adapter adjacent to the second insertion core, and the second claw assembly has a second abutting surface for abutting the second insertion core;
wherein, when the first insertion core and the second insertion core are not inserted into the insertion cavity, an initial distance is present between the first abutting surface and the second abutting surface in the first direction, and the initial distance is smaller than a sum of lengths of the first insertion core and the second insertion core in the first direction.

12. The active optical cable according to claim 11, characterized in that
each of the first claw assembly and/or the second claw assembly has an observation hole to measure the initial distance through the observation hole.
